(19) United States
(12) Patent Application Publication
(10) Pub. No.: US 2004/0077376 A1
(43) Pub. Date: Apr. 22, 2004

(54) Adaptive personal identification device for mobile telephone

(76) Inventors: George Fang, Summit, NJ (US); Giovanni Vannucci, Red Bank, NJ (US)

Correspondence Address: Mitsubishi Electric Research Laboratories, Inc., Patent Department, 201 Broadway, Cambridge, MA, 02139, US

(21) Appl. No.: 10/403,777

(22) Filed: Mar. 31, 2003

Related U.S. Application Data
(63) Continuation-in-part of application No. 10/364,146, filed on Feb. 11, 2003.
Application No. 10/364,146 is a continuation-in-part of application No. 10/277,709, filed on Oct. 22, 2002.

(51) Int. Cl. H04M 1/00

(52) U.S. Cl. 455/557; 455/550.1

(57) ABSTRACT

A method adapts a signal transmitted by a mobile telephone. Simulated telephone activity to be transmitted as a radio signal by the mobile telephone is generated in a hands-free kit to be plugged into a voice or data connector of the mobile telephone. The mobile telephone transmits the simulated telephone activity as a radio signal. The radio signal is detected by an antenna of the hands-free kit. The detected radio signal is then used to adjust the simulated telephone activity as it is being generated. The adjusting can alter the timing and amplitude of the simulated telephone activity to conform to an air interface standard of the radio signal.

### RELATED APPLICATION

This application is a continuation-in-part patent application of U.S. patent application Ser. No. 10/364,146, “Personal Identification Device For Mobile Telephone,” filed on Feb. 11, 2003, which is a continuation-in-part of U.S. patent application Ser. No. 10/277,709, “Mobile Telephone Messaging by Baseband Envelope Modulation,” filed on Oct. 22, 2002.

### FIELD OF THE INVENTION

This invention relates generally to wireless communications systems, and more particularly to locating and identifying a mobile telephone.

### BACKGROUND OF THE INVENTION

Mobile telephones are widely used because of their ability to communicate at a variety of locations.

FIG. 1 depicts a typical prior art mobile telephone communication system 100. The system comprises a mobile telephone 110, which transmits an uplink radio signal 111 to a base station 120. The base station 120 transmits a downlink radio signal 112 to the mobile telephone. The base station 120 is also connected to a telephone equipment 130 through a connection 122, which is usually part of the public switched telephone network (PSTN). The telephone equipment 130 can include other telephones, automated answering units or a modem connected to a computer, and a server 140. The system 100 provides a point-to-point two-way connection between the mobile telephone 110 and the telephone equipment 130. A frequently used accessory for mobile telephones is a hands-free kit (HFK).

FIG. 2 shows a typical prior-art HFK 200 used in conjunction with the mobile telephone 110. The kit includes a male jack 210, which is coupled to a female jack 220 attached to a housing of the mobile telephone 110. The HFK 200 further includes a cable 230 and an earpiece 240. The earpiece 240 is coupled to the cable 230 and is adapted to generate an audible sound signal in response to an electrical signal received from the mobile telephone 110 through the male jack 210 and the female jack 220 and the cable 230.

The HFK 200 further includes a microphone 250. The microphone 250 is also coupled to the cable 230 and is adapted to generate an electrical signal in response to a detected sound signal. The signal generated by the microphone 250 is conveyed to the mobile telephone 110 through the cable 230 and the male jack 210 and the female jack 220. As an advantage, the user of a mobile telephone can wear the HFK 200, thus freeing the user's hands to perform other tasks.

As described in the related application, the mobile telephone 110 can use simulated telephone activity to communicate wirelessly with a receiver that detects an envelope of the radio transmission. The simulated telephone activity can be a voice signal or a data signal. A typical application for this communication technique locates, identifies, or authenticates the mobile telephone. This application is typically realized through a connection to an authentication server 140 connected to the telephone equipment 130. The personal identification device described in the related application realizes such a connection without having to modify existing mobile telephones, wireless networks, and wireless communications air interface standards. The personal identification device described in the related application is an external device for a mobile telephone so that the mobile telephone is enabled for the functionality described above, without requiring modifications to the mobile telephone.

The parameters of the radio signal transmitted by the mobile telephone are defined by an air interface standard, for example, the Global System for Mobile communications, or GSM, standard. Therefore, the details of the design of the personal identification device is adapted to the air interface standard being used, in order to achieve optimum performance. It would be advantageous to have a single PID design that provides optimum performance with a multiplicity of air interface standards.

It would also be advantageous to have a personal identification device that guarantees that the envelope of the radio transmission from a mobile telephone follows the desired pattern exactly. It would also be advantageous to have a personal identification device that obtains power from the mobile telephone and does not require an independent power supply or battery.

### SUMMARY OF THE INVENTION

The present invention provides a personal identification device (PID) that can be plugged into a jack of a mobile telephone in a similar manner as a hands-free kit. The PID includes an antenna capable of receiving a radio signal transmitted by the mobile telephone. By monitoring the pattern of envelope variations of the detected radio signal, the PID detects the air interface standard being used by the mobile telephone. For example, the air interface standard can be the Global System for Mobile communications (GSM), standard. After determining the air interface standard, the PID can adaptively optimize its own operation for the standard being used.

The personal identification device generates simulated telephone activity, e.g., voice or data signals. The purpose of the simulated telephone activity is to cause the mobile telephone to transmit a radio signal with a specific pattern of envelope variations. The PID provided by this invention monitors the envelope pattern that is actually transmitted and adjusts the parameters of the simulated telephone activity to better insure that the desired pattern is transmitted.

The PID needs electrical power to perform its functions. While it is possible to use a battery as the source of power, the PID provided by this invention eliminates the need for a battery by extracting electrical power from the signal that it receives from the earphone jack.

### BRIEF DESCRIPTION OF THE DRAWINGS

FIG. 1 is a block diagram of a conventional mobile communications network that uses the device according to the invention;

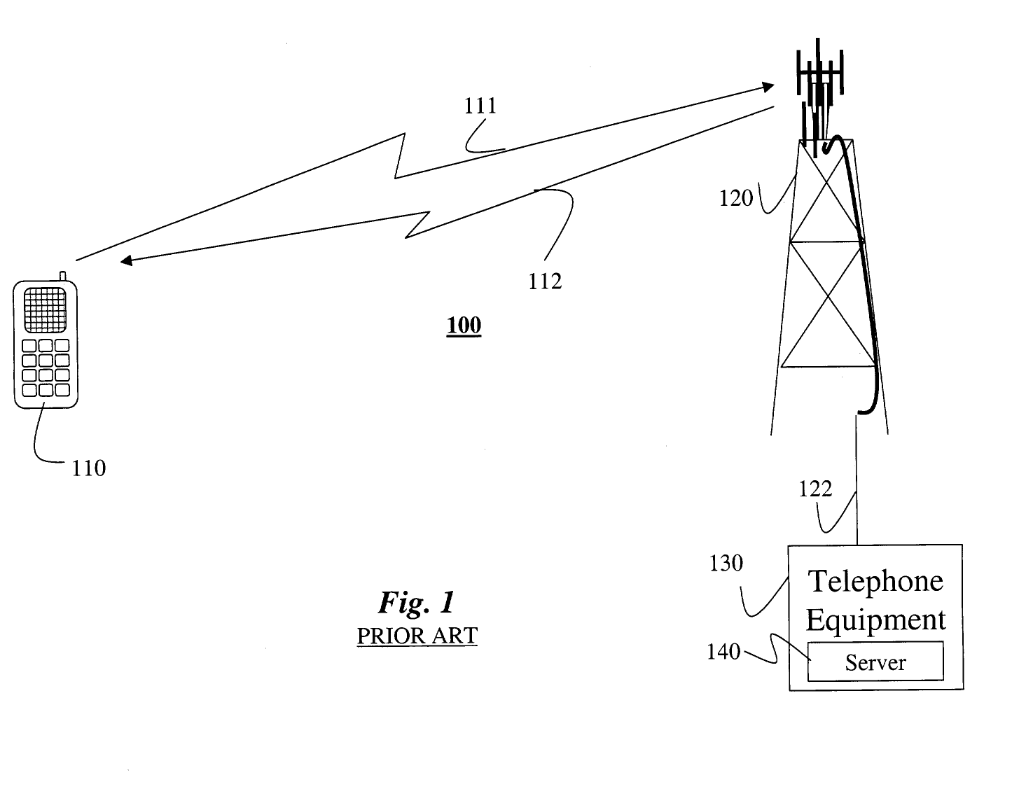

FIG. 2 is a block diagram of a prior art hands-free kit;

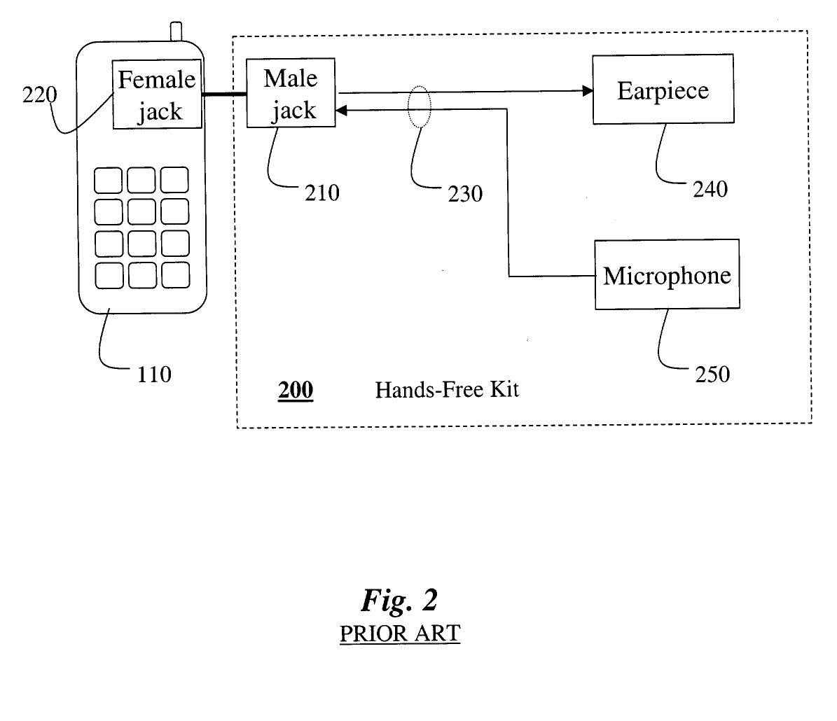

FIG. 3 is a block diagram of basic functional components of a personal identification device according to the invention;

FIG. 4 is a block diagram of a personal identification system according to the invention;

FIG. 5 is a block diagram of detailed functional components of a personal identification device according to this invention; and

FIG. 6 is a flow diagram of a method according to the invention.

### DETAILED DESCRIPTION OF THE PREFERRED EMBODIMENT

Basic Device Structure and Operation

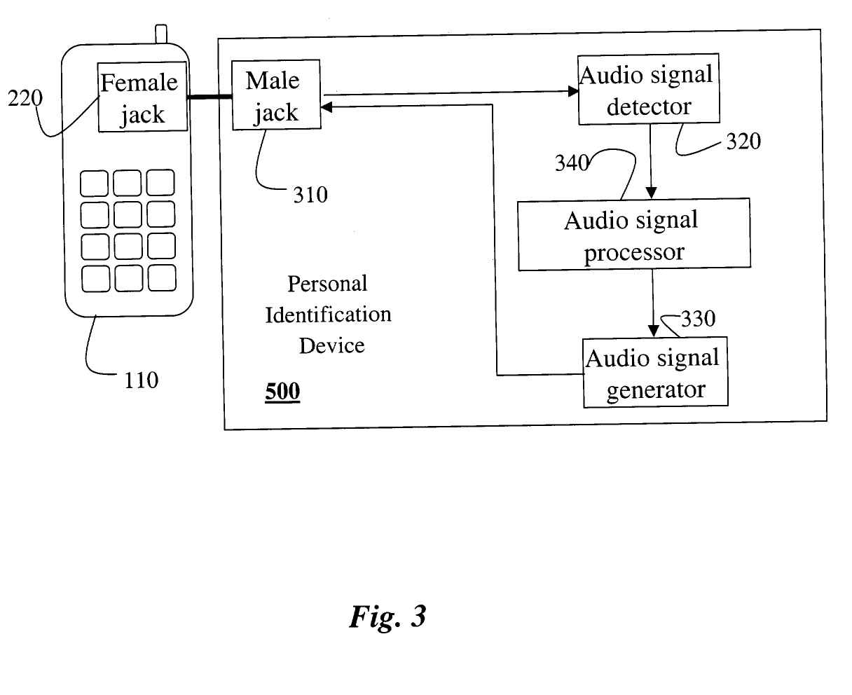

FIG. 3 shows the basic functional components of a personal identification device 500 (PID) that can be plugged into a jack 220 of a mobile telephone 110 in a manner as a hands-free kit 200. The basic operation of the device is described in the related U.S. patent applications, incorporated herein in their entirety by reference.

The PID 500 receives a first telephone signal from the mobile telephone 110 via the jack 310. However, instead of producing a sound in an earpiece, as in a conventional HFK 200, the PID extracts a first message encoded in the first telephone signal using the audio signal detector 320. The detected signal is processed 340. Based on the contents of the encoded first message, the PID generates 330 a second telephone signal, which is supplied to the mobile telephone through the jack 310 in the same manner as the conventional HFK 200 delivers a signal obtained from the microphone 250. The second telephone signal simulates the telephone activity of a real telephone user for the purpose of causing the mobile telephone 110 to transmit a radio signal 111 whose envelope is modulated in a pattern that follows the simulated telephone activity. The simulated telephone activity can by in the form of voice or data signals.

Personal Identification System

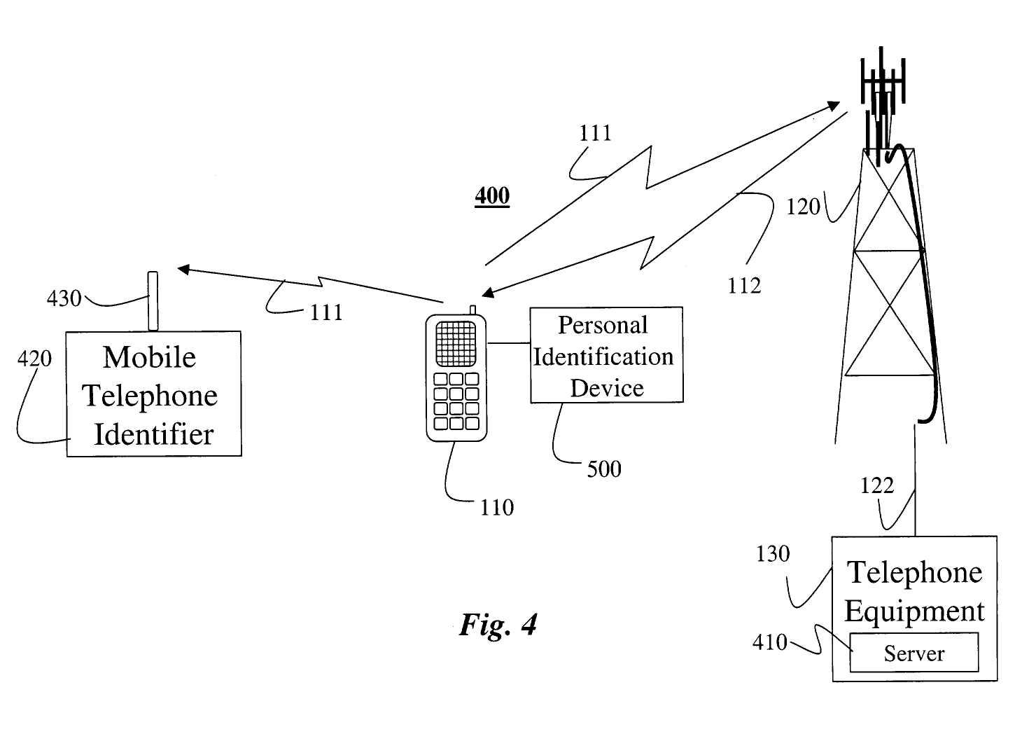

FIG. 4 shows a personal identification system based on modulating the envelope of the radio signal 111 by means of simulated telephone activity. A mobile telephone identifier 420 located in the vicinity of the mobile telephone 110 detects the modulated envelope of the transmitted signal 111. The PID 500 adjusts the simulated telephone activity so as to encode a second message into the pattern of transmitted envelope variations. The second message conveys an identity of the mobile telephone 110. The mobile telephone identifier 420 decodes the second message and, thereby, identifies the mobile telephone 110.

The parameters of the radio signal transmitted by the mobile telephone are defined by an air interface standard, for example, the Global System for Mobile communications, or GSM, standard. Therefore, the details of the design of the PID 500 are adapted to the air interface standard being used, in order to achieve optimum performance. It would be advantageous to have a single PID design that provides optimum performance with a multiplicity of air interface standards.

Detailed Device Structure

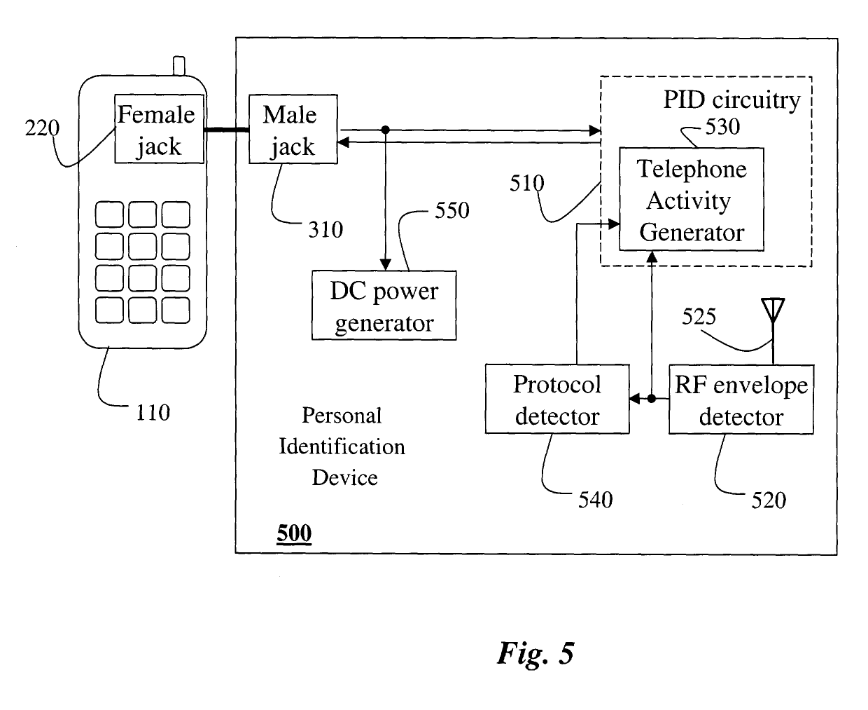

FIG. 5 shows the detailed structure of the personal identification device (PID) 500 according to the invention. The PID 500 includes the basic functional components shown in FIG. 3, denoted by a PID circuitry 510. The PID 500 also includes a radio antenna 525 connected to a radio frequency (RF) envelope detector 520. The envelope detector 520 generates a detected RF envelope that is fed to an audio signal generator 530 and to a protocol detector 540.

The protocol detector 540 identifies the radio communication protocol used by the mobile telephone 110 by examining the pattern of envelope variations in the radio signal transmitted by the mobile telephone. Because different air interface standards use different protocols, the protocol detector 540 identifies the air interface standard is used by the mobile telephone. The protocol detector communicates the identity of the air interface standard used by the mobile telephone to the audio generator 530. The audio generator then selects a specific procedure to adapt the second signal to the air interface standard being used.

The direct connection from the RF envelope detector 520 to the audio signal generator 530 is advantageous because the connection enables the audio signal generator to observe the effects of the audio signal that are generated. For example, if the level or the timing of the audio signal are not what they should be to cause the mobile telephone 110 to transmit the desired pattern of RF envelope, then the audio signal generator 530 is able to observe the discrepancy and can adjust the level or the timing of the generated audio signal as needed to achieve the desired result.

Other parameters of the audio signal can be also adjusted in such closed-loop fashion. For example, the spectral contents and the autocorrelation properties of the simulated telephone activity are adjusted by the audio signal generator 530 so as to closely mimic normal speech. If the simulated telephone activity is not recognized by the mobile telephone 110 as speech, then the RF envelope does not exhibit the desired pattern. In that situation, the audio signal generator can adjust spectral contents or autocorrelation or both to better achieve the desired RF envelope pattern.

A DC power generator 550 extract power from the telephone audio signal provided by the mobile telephone through the female jack 220. Because the audio signal provided by the mobile telephone is intended to drive a passive earpiece 240 with enough power to generate an audible sound, it has the ability to deliver a predetermined power level sufficient for sound generation.

The DC power generator 550 rectifies the audio signal provided by the mobile telephone conventionally. The rectification extracts a portion of the power contained in the signal, and converts it to a direct current (DC) suitable for powering the electronic circuits of the PID 500.

The design of a rectifier to achieve the desired rectification is well known. Generally, the rectifier includes a capacitor. If substantial storage of electrical energy is needed, for example, in situations where the source of power is not steady or is unreliable, the capacitance of the capacitor can be made large. Other more substantial storage means, such as a rechargeable battery, may also be used.

An advantageous feature of this invention is that the first telephone signal is deliberately devised to have a constant power level which enables the rectifier to deliver a continuous power output without requiring a large capacitor for energy storage. Alternatively, the first signal can have a power level which, though not constant, exhibits steady or predictable variations, such that the rectifier needs only a small capacitor for storage. For example, the first telephone signal can be a stream of DTMF codes with no gaps between consecutive DTMF codes.

Detailed Device Operation

During operation, the PID 500 is connected to the female jack 220 of the conventional mobile telephone 110 and the mobile telephone is engaged in a telephone call to the server 140. The server 140 is capable of generating a first audio telephone signal containing a first message. The first message can be encoded into the first telephone signal through any of a variety techniques well known in the art, for example the message can be encoded by frequency modulating an audio carrier through a technique known as frequency-shift keying (FSK). The audio signal travels over the downlink radio signal 112 to the mobile telephone 110, where it is made available out of the female jack 220.

An advantage of FSK modulation is that the amplitude of the FSK modulated signal is constant. Correspondingly, the power level delivered by the mobile telephone 110 through the jack 220 for the purpose of driving the earpiece 240 is also constant. In the PID 500, the constant power level is converted to a steady DC supply by the DC power generator 550. Other modulation schemes that supply a constant or nearly constant power level are well known and can be used in alternative embodiments of the invention. The signal delivered by the mobile telephone 110 through the jack 220 is also received by the PID circuitry 510 for the purpose of decoding the first message; however, only a small portion of the power in the signal is needed for this purpose and most of the power remains available for the DC power generator 550.

The audio signal generator 530 is adapted to generate a second telephone signal with intensity and spectrum similar to an electrical signal produced by the microphone 250. Additionally, the second audio telephone signal exhibits a pattern of activity that simulates a voice activity of a conventional voice communication, and that we refer to as simulated telephone activity. If the device is plugged into a data port of the mobile telephone, then the simulated telephone activity is in the form of a data signal.

U.S. patent application Ser. No. 10/277,709, “Mobile Telephone Messaging by Baseband Envelope Modulation,” filed on Oct. 22, 2002, incorporated herein by reference explains the details of the simulated telephone activity. The simulated telephone activity causes the mobile telephone 110 to vary the RF envelope of the transmitted signal. This is because the mobile telephone reduces the average power level of the transmitted radio signal during periods when it detects no telephone activity from the microphone. This reduction is reflected in the envelope of the radio signal transmitted by the mobile telephone in a manner that depends on the air interface standard. For example, in the GSM standard, more bursts of radio signal are transmitted during telephone activity than during silent periods.

In the PID 500, the antenna 525 receives the radio signal transmitted by the mobile telephone 110, and the RF envelope detector 520 detects the signal's envelope. Because of the close proximity of the antenna 525 to the transmitting antenna of the mobile telephone 110, the transmitted signal is easy to detect, and is much stronger than any other interfering radio signals. Therefore, the design of the RF envelope detector 520 can be simplified because very little amplification is needed, and interference from other nearby radio sources is negligible, so that no filtering is required.

The RF envelope detector 520 communicates the pattern of envelope variations to the protocol detector 540, which analyzes the pattern to determine which air interface standard is being used by the mobile telephone 110. The audio signal generator 530 can include multiple procedures. Each procedure is adapted optimally for a different air interface standard.

The protocol detector 540 communicates to the audio signal generator 530 the identity of the air interface standard being used, and the audio signal generator can execute a procedure optimized for the standard being used.

The audio signal generated by the audio signal generator 530 is treated by the mobile telephone 100 as if it were a telephone signal generated by the microphone 250. A voice encoder first digitizes the signal, and the resulting bit stream is then modulated onto a radio carrier for transmission. The details of how the voice encoder digitizes the signal are defined by the air interface standard being used by the mobile telephone. Generally, the voice encoder breaks up the signal into consecutive segments known as voice frames. For example, in the GSM standard, voice frames are segments of 20 ms in duration.

Each voice frame is digitized and transmitted separately. For example, in the GSM standard, each voice frame is transmitted as a sequence of four bursts of radio transmission. Before digitizing a voice frame, the voice encoder determines if the frame contains a voice signal, or if it contains silence, or background noise. Generally, if the voice frame contains a voice signal, then the signal is transmitted. If the signal contains noise or silence, then the signal may or may not be transmitted or it may be transmitted in a more compact format.

The action depends on a voice gating process in use, which depends on the air interface standard in use. Because the audio signal generator 530 uses a procedure that is optimized for the air interface standard being used, the generator can take full advantage of the characteristics of the voice encoder to achieve the desired RF envelope in the mobile telephone's transmission.

Additionally, the audio signal generator 530 can observe directly the RF envelope of the transmitted signal, and the generator can determine the timing of the transmitted bursts. Because the transmitted bursts reflect how the voice signal is segmented into voice frames, the audio generator 530 can thus learn the timing of the voice frames as defined by the voice encoder. The audio signal generator 530 can then adjust the timing of the simulated telephone activity generated to maximize its effectiveness.

For example, the generator can generate simulated voice activity followed by simulated silence in such a way that the boundary between voice and silence matches the boundary between two voice frames. This maximizes the rate at which the simulated telephone activity can alternate between simulated telephone and silence without causing an unpredictable response by the voice encoder. The feature is accomplished by including in the audio signal generator 530 means for adjusting the timing of the second signal containing simulated telephone activity in response to an observed pattern from the RF envelope detector 520.

Generally, the voice encoder in the mobile telephone determines when speech activity is present by setting a threshold. If the signal level exceeds the threshold, then the signal is regarded as a voice signal. If not, then the signal is regarded as silence or noise.

The simulated telephone signal generated by the audio signal generator 530 is strong enough to exceed the threshold, while the background noise present otherwise does not exceed the threshold. Because the PID does not use a microphone, background noise is essentially eliminated. The ability of the audio signal generator 530 to monitor the RF envelope directly allows the generator to adjust the signal level as needed to achieve the desired result. Other parameters of the simulated telephone activity signal can be also adjusted in a similar closed-loop fashion.

As described above, the spectral contents and the autocorrelation properties of the simulated telephone activity can be adjusted by the audio signal generator 530. More generally, any parameter of the structure of the generated audio signal can be adjusted by the audio signal generator 530 in a closed-loop fashion, that is, by varying the parameter while observing the resulting changes in the detected RF envelope, and by subsequently adjusting the value of the parameter so as to achieve a desired RF envelope pattern.

This feature is accomplished by including in the audio signal generator 530 means for adjusting the structure of the second signal in response to an observed pattern from the RF envelope detector 520. Transmission errors are a common occurrence in all communication systems, and many techniques have been developed to combat these errors and achieve error-free communication despite an unreliable channel. For example, if a receiver detects that errors are present in a received message, then the receiver can send a response back to the transmitter requesting that the message be transmitted again, so that the errors can be corrected.

In the case of the PID, transmission errors may occur when the normal operation of the voice encoder is disrupted. For example, when the mobile telephone 110 executes a handover, radio transmission from the mobile telephone may be momentarily suspended and, when the transmission resumes, the state of the voice encoder may be reset by the mobile telephone.

Correspondingly, for a short period of time during a handover, the envelope of the transmission may not reflect the simulated telephone activity generated by the audio signal generator 140. Other events may also occur as part of the normal operation of the mobile telephone 110 that cause similar disruptions.

The present invention is particularly advantageous because it compensates for the kind of disruptive events described in the previous paragraph. Because the audio signal generator 530 continually monitors the transmitted RF envelope, the generator is able to detect any disruptions immediately, as they occur, by the fact that the transmitted RF envelope does not follow the simulated telephone activity as desired. Thus, in a manner similar to the error-correction example above, when the audio signal generator 530 detects a discrepancy between the transmitted RF envelope and the simulated telephone activity, the generator can optimally regenerate the message encoded into the simulated telephone activity so that the message can be detected without errors.

In combination, the techniques described in the previous paragraphs enable the PID to optimize the second signal delivered to the mobile telephone 110 through the male jack 310 in a closed-loop fashion through monitoring of the actual RF envelope transmitted by the mobile telephone 110. That is, the PID can adjust any feature of the generated second signal and, by monitoring the resulting changes in the RF envelope generated by the mobile telephone, the PID can optimize the adjustment to achieve an optimized generated second signal. This is accomplished by including in the PID 500 means for adjusting the second signal in response to an observed pattern from the RF envelope detector 520.

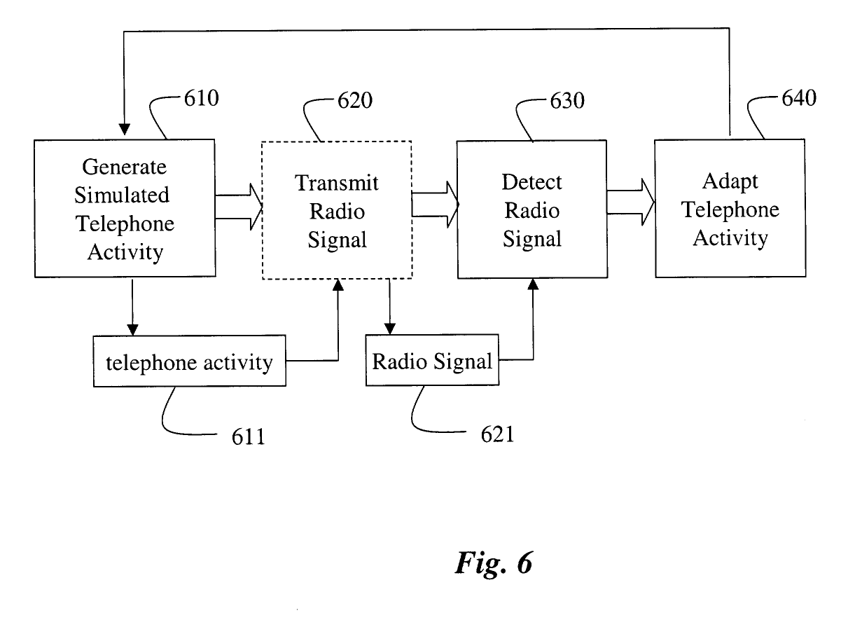

FIG. 6 shows a basic method 600 used by the invention. The step in a dashed outline is performed in the mobile telephone. First, simulated telephone activity 611 is generated 610. In a typical application, the simulated telephone activity encodes a unique identity of the mobile telephone or the PID 500. The simulated telephone activity is transmitted 620 as a radio signal 621 by the mobile telephone. The transmitted radio signal 621 s detected 630, and the simulated telephone activity is adapted 640 according to the detected radio signal while generating the simulated telephone activity.

Effect of the invention

The present invention eliminates the need for a power source in the personal identification device. It allows the manufacturer of the personal identification device to produce a single, universal model that works with all mobile telephones, regardless of what air interface standard the telephones use. This is particularly advantageous for users of multi-standard mobile telephones. The invention eliminates the risk of errors in the identification message conveyed to the identifier. The invention also maximizes the speed of transmission of the identification message.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

We claim:

1. An apparatus for use with a mobile telephone in a wireless communications network, comprising:
a connector configured to connect to a mating connector of a mobile telephone;
means, coupled to the connector, for generating simulated telephone activity to be transmitted as a radio signal by the mobile telephone;
means for detecting the transmitted radio signal corresponding to the simulated telephone activity; and
means, connected to the means for generating and means for detecting, for adapting the simulated telephone activity according to the detected radio signal while generating the simulated telephone activity.

2. The apparatus of claim 1 wherein the simulated telephone activity is a voice signal.

3. The apparatus of claim 1 wherein the simulated telephone activity is a data signal.

4. The apparatus of claim 1 wherein the simulated telephone activity encodes a unique identification.

5. The apparatus of claim 1 wherein the simulated telephone activity is generated in response to radio signal received by the telephone.

6. The apparatus of claim 1 further comprising:
means for identifying an air interface standard of the detected radio signal; and
means for adapting the simulated telephone activity according to the air interface standard.

7. The apparatus of claim 1 further comprising:
means for detecting an envelope of the detected radio signal.

8. The apparatus of claim 1 wherein a timing of the simulated telephone signal is adjusted.

9. The apparatus of claim 1 wherein a signal level of the simulated telephone activity is adjusted.

10. The apparatus of claim 1 wherein the means for generating, the means for detecting, and then means for adjusting form a closed loop.

11. The apparatus of claim 1 wherein a spectral content of the simulated telephone activity is adjusted.

12. The apparatus of claim 1 wherein autocorrelation properties of the simulated telephone activity are adjusted.

13. The apparatus of claim further comprising:
means for extracting power from mobile telephone.

14. The apparatus of claim 1 wherein the means for extracting power includes a rectifier.

15. The apparatus of claim 2 wherein the simulated telephone activity further includes simulated silence.

16. The apparatus of claim 2 wherein an amplitude of the simulated telephone signal exceeds a predetermined threshold.

17. The apparatus of claim 1 further comprising:
means for detecting disruptions in the detected radio signal; and
means for regenerating the simulated telephone activity in response to the detected disruptions.

18. A method for adapting a signal transmitted by a mobile telephone, comprising:
generating simulated telephone activity to be transmitted as a radio signal by a mobile telephone;
detecting the transmitted radio signal corresponding to the simulated telephone activity; and
adapting the simulated telephone activity according to the detected radio signal while generating the simulated telephone activity.
